(19) United States
(12) Patent Application Publication
(10) Pub. No.: US 2024/0410721 A1
(43) Pub. Date: Dec. 12, 2024

(54) CONDUCTOR TRACK STRUCTURE, ROTOR, ROTATION ANGLE SENSOR UNIT AND METHOD FOR PRODUCING A ROTOR FOR A ROTATION ANGLE SENSOR UNIT

(71) Applicant: HELLA GmbH & Co. KGaA, Lippstadt (DE)

(72) Inventors: Martin PANKOKE, Paderborn (DE); Keramettin SEVEN, Lippstadt (DE)

(73) Assignee: HELLA GmbH & Co. KGaA, Lippstadt (DE)

(21) Appl. No.: 18/808,073

(22) Filed: Aug. 18, 2024

Related U.S. Application Data
(63) Continuation of application No. PCT/EP2023/052763, filed on Feb. 6, 2023.

(30) Foreign Application Priority Data
Feb. 17, 2022 (DE) 10 2022 103 734.7

(51) Int. Cl. G01D 5/20

(52) U.S. Cl. CPC G01D 5/2053

(57) ABSTRACT

A conductor track structure for a rotor of a rotation angle sensor comprising an annularly designed conductor track with a meander-shaped conductor track profile. At least one positioning projection projecting inwards in a radial direction for the positive and/or non-positive positioning of the conductor track structure is arranged on the conductor track in an injection molding tool. A rotor having a conductor track structure, a rotation angle sensor unit having a rotor, and a method for producing a rotor are also provided.

This nonprovisional application is a continuation of International Application No. PCT/EP2023/052763, which was filed on Feb. 6, 2023, and which claims priority to German Patent Application No. 10 2022 103 734.7, which was filed in Germany on Feb. 17, 2022, and which are both herein incorporated by reference.

### BACKGROUND OF THE INVENTION

### Field of the Invention

The present invention relates to a conductor track structure for a rotor of a rotation angle sensor, having a ring-shaped conductor track with a meandering conductor track pattern. The invention further relates to a rotor for a rotation angle sensor unit, a rotation angle sensor unit, and a method for producing a rotor for a rotation angle sensor unit.

### Description of the Background Art

Various approaches are known in the prior art for implementing inductive torque sensor units. Torque sensor units are used in motor vehicles, for example to determine torques such as steering torques. This is becoming increasingly necessary due to the growing use of electric motor-driven servo units for steering assistance, which for control require a magnitude of the steering torque. Steering torques are identifiable in a steering column as differential angles by use of a shaft and in particular a torsion bar, and are calculated from these differential angles. For this purpose, the twisting at the ends of the torsion bar is determined in the form of signals, using a suitable apparatus, and is supplied to evaluation units. The differential angles brought about by the torsion may be determined independently of the position of the steering wheel. In addition, for driver assistance systems, for example, it is important to know the position of the steering wheel. For this purpose, a turning angle of the steering wheel is determined using a rotation angle sensor unit.

EP 2 870 033 B1, which corresponds to US 2015/0168140, which is incorporated herein by reference, describes numerous further variants of known rotation angle sensor units.

For the most accurate determination of the steering angle possible, it is important for the various functional components such as the circuit board, housing, rotor, and stator to be manufactured in a particularly precise manner. For a generic rotor, the evenness of various component surfaces as well as the rotational symmetry of the rotor play an important role. In this regard, in manufacturing the rotor the challenge, among others, is to align a conductor track structure with a rotor sleeve as precisely as possible. Meandering conductor track structures may be affixed to the rotor sleeve by injection molding, wherein the most precise positioning possible of the conductor track structure with respect to the rotor sleeve during the injection molding poses a certain challenge. Furthermore, rotors are known in which the particular conductor track structure and the rotor sleeve are provided as an integral or monolithic component. However, an additional challenge here is aligning the conductor track structure as precisely as possible with respect to the rotor sleeve and correspondingly installing it in the rotation angle sensor unit.

### SUMMARY OF THE INVENTION

It is therefore an object of the present invention to at least partially take the above-described problem into account. In particular, the object of the present invention is to manufacture a rotor for use in generic rotation angle sensor units with the greatest possible precision.

The above object is achieved a conductor track structure, a rotor, a rotation angle sensor unit, and a method. Of course, features that are described in conjunction with the conductor track structure also apply in conjunction with the rotor according to the invention, the rotation angle sensor unit according to the invention, and the method according to the invention, and vice versa in each case, so that with regard to the disclosure, mutual reference is or may always be made to the individual aspects of the invention.

According to a first aspect of the present invention, a conductor track structure for a rotor of a rotation angle sensor is proposed. The conductor track structure can have a ring-shaped conductor track with a meandering conductor track pattern, wherein at least one positioning protrusion that projects inwardly in a radial direction is provided at the conductor track for the form-fit and/or force-fit positioning of the conductor track structure in a mold.

It has been found that by use of the at least one positioning protrusion, a simple means may be provided for precisely and reliably positioning or aligning the conductor track structure relative to the rotor sleeve in a mold, in particular an injection mold. This means that the at least one positioning protrusion may preferably be configured and/or designed for the form-fit and/or force-fit positioning of the conductor track structure in the injection mold. The at least one positioning protrusion may be easily provided as a nose-shaped retaining protrusion at a base shape of the conductor track structure, and may completely disappear in the injection molding during the subsequent production process for the rotor. However, the at least one positioning protrusion is naturally not to be construed as being limited to a nose or peg shape. Rather, other shapes of protrusions, in particular more complex geometries, are possible. Thus, there is also no subsequent risk of injury and/or damage from the at least one positioning protrusion. Additional retainers and/or retainers that are spaced apart from the conductor track structure for achieving the most precise relative positioning possible between the conductor track structure and the rotor sleeve may be dispensed with. A rotor may thus be produced in a particularly simple manner using the proposed conductor track structure.

The conductor track structure may be provided as a closed ring structure. This means that the meandering conductor track pattern, considered as a whole, preferably extends in a ring shape. The conductor track structure may thus be easily positioned in an injection mold, above a rotor sleeve or around the rotor sleeve. The meandering conductor track pattern may be a conductor track pattern or a correspondingly configured conductor track that extends in a winding and/or zigzag manner. The conductor track or a side face of the conductor track extends in the circumferential direction, preferably in a plane. This means that a top side and/or a bottom side of the conductor track and/or of the conductor track structure in each case extend(s) in a plane.

It is possible that for a conductor track structure, the conductor track can have outer conductor track segments and inner conductor track segments, the outer conductor track segments being provided farther outwardly in a radial direction than the inner conductor track segments, and a positioning protrusion that projects inwardly in the radial direction being provided at at least one inner conductor track segment. The at least one positioning protrusion may thus have a particularly short and correspondingly material-saving design and still meet the desired positioning function. The at least one positioning protrusion in each case preferably extends centrally and radially inwardly from the inner conductor track segment.

Furthermore, it is possible that for a conductor track structure according to the invention, in each case a positioning protrusion that projects inwardly in the radial direction can be provided at multiple inner conductor track segments. In each case one or at least one inwardly projecting positioning protrusion is particularly preferably provided at each inner conductor track segment or at least at every second or every third inner conductor track segment. The conductor track structure may thus preferably have a plurality, for example more than 4 or more than 12, positioning protrusions. With such a number of positioning protrusions, the positioning protrusions may each be relatively short and small and still reliably contribute to the desired positioning accuracy of the conductor track structure in the injection mold. In addition, short positioning protrusions have relatively high stability compared to possibly longer positioning protrusions. Damage to the positioning protrusions during production of the rotor and resulting inaccuracy in the alignment of the conductor track structure with respect to the rotor sleeve may be prevented in this way.

Multiple positioning protrusions that project inwardly in the radial direction can be provided at the conductor track. This means that, in contrast to the example variant described above, the radial inwardly projecting positioning protrusions may also project radially inwardly from some other position, for example from the outer conductor track segments.

The positioning protrusions can each project radially inwardly in a range between 0.5 mm and 2 mm. This means that the positioning protrusions may each project radially inwardly with a length in a range between 0.5 mm and 2 mm. Tests within the scope of the present invention have shown that the positioning protrusions are relatively small and correspondingly material-saving, but still achieve the desired technical effect with regard to the most precise positioning possible of the conductor track structure during production of the rotor in the injection mold. The positioning protrusions particularly preferably extend radially inwardly from the conductor track with a length of approximately 1 mm.

The conductor track can be made of an electrically conductive and non-magnetizable or essentially non-magnetizable material. Electromagnetic interactions with further functional components of the rotation angle sensor unit and/or in the vicinity of the rotation angle sensor unit may thus be reliably prevented.

For a conductor track structure according to the invention, the conductor track, including the at least one positioning protrusion, can also be designed in one piece and/or as a monolithic component. The conductor track structure may thus be manufactured particularly easily, for example as a stamped part, a lasered sheet metal part, or as a 3D printing part. In addition, a monolithic conductor track structure is particularly stable and unsusceptible to errors.

A further aspect of the present invention relates to a rotor for a rotation angle sensor unit, having a rotor sleeve and a conductor track structure as described above, the conductor track structure being affixed to the rotor sleeve by injection molding. By use of the conductor track structure according to the invention, the rotor also provides the advantages described above. The conductor track structure is preferably annularly positioned around the rotor sleeve. The statement that “the conductor track structure is affixed to the rotor sleeve by injection molding” may be that an injection-molded component is provided between the conductor track structure and the rotor sleeve which holds the conductor track structure in a predefined position relative to the rotor sleeve and/or at the rotor sleeve.

Within the scope of the present invention, a rotation angle sensor unit for determining a rotational angle between a rotor as described above and a stator is also proposed, the rotation angle sensor unit including a housing that defines a housing volume; the rotor, which is rotatably supported in the housing volume; the stator; and a circuit board to which the stator is affixed. The rotation angle sensor unit also provides the advantages described above.

Furthermore, an aspect of the invention relates to a method for producing a rotor as described above, comprising the steps: positioning the conductor track structure in a mold by means of the at least one positioning protrusion, providing the rotor sleeve in the mold, and affixing the conductor track structure to the rotor sleeve by injection molding via the mold.

The method according to the invention thus also provides the advantages described above. The conductor track structure can be affixed to the rotor sleeve in particular by injection molding at the at least one positioning protrusion, so that the at least one positioning protrusion is in each case preferably completely enclosed or bordered by the injection molding.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an exploded illustration of a rotation angle sensor;

FIG. 2 shows a rotor with a conductor track structure according to the invention;

FIG. 3 shows a top view of a conductor track structure according to one an example of the present invention;

FIG. 4 shows a perspective illustration of a conductor track structure according to the invention, and a rotor sleeve; and

FIG. 5 shows a flow chart for explaining a method for producing a rotation angle sensor according to the invention.

### DETAILED DESCRIPTION

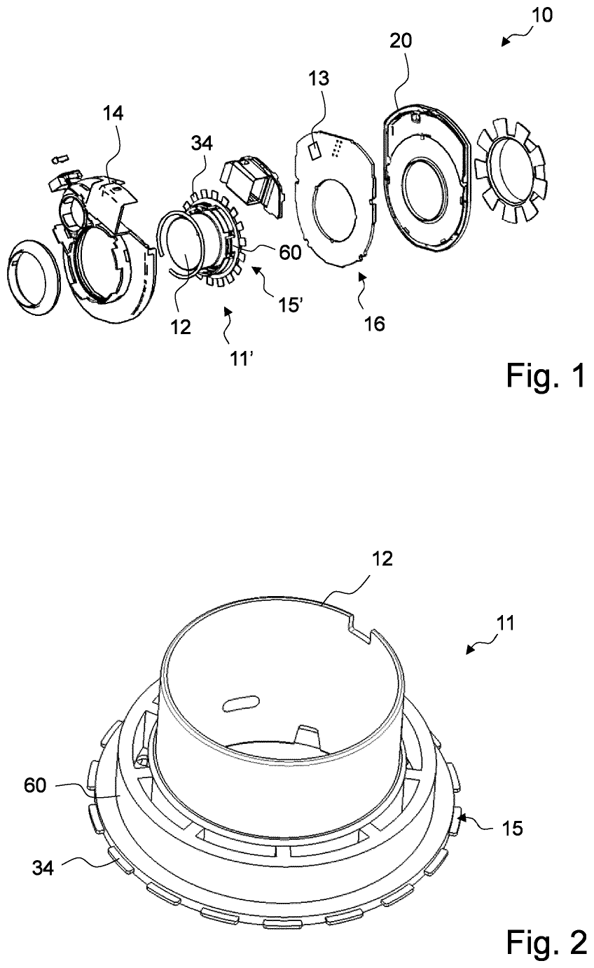

FIG. 1 shows an exploded illustration of a generic rotation angle sensor unit 10 that is designed for determining a rotational angle between a rotor 11′ and a stator 13. The rotation angle sensor unit 10 has a housing 14 that defines a housing volume; the rotor 11′, which is rotatably supported in the housing volume; the stator 13; and a circuit board 16 to which the stator 13 is affixed. The rotor 11′ has a rotor sleeve 12 and a conductor track structure 15′, the conductor track structure 15′ being affixed to the rotor sleeve 12 by injection molding 60.

FIG. 2 shows a rotor 11 for a rotation angle sensor unit 10 as illustrated in FIG. 1. The rotor 11 has a rotor sleeve 12 and a conductor track structure 15, the conductor track structure 15 being affixed to the rotor sleeve 12 by injection molding 60.

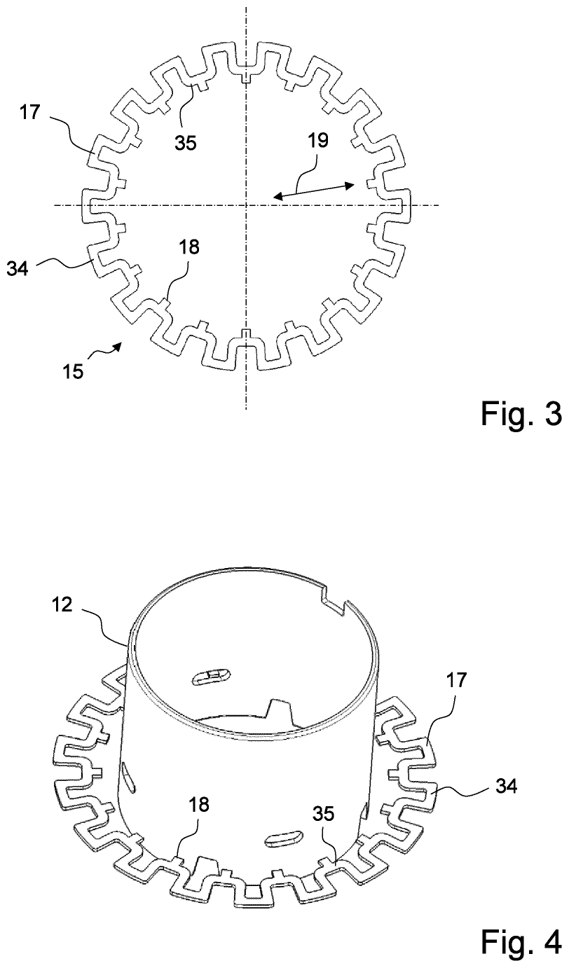

FIG. 3 shows a conductor track structure 15 of the rotor 11 illustrated in FIG. 2, in a top view. As is apparent in FIG. 3, the conductor track structure 15 has a ring-shaped conductor track 17 with a meandering conductor track pattern. The conductor track 17 has outer conductor track segments 34 and inner conductor track segments 35. The outer conductor track segments 34 are provided farther outwardly in a radial direction 19 than the inner conductor track segments 35. Positioning protrusions, projecting inwardly in the radial direction 19, for the form-fit and/or force-fit positioning of the conductor track structure 15 in an injection mold are provided at the inner conductor track segments 35. The positioning protrusions 18 each protrude approximately 1 mm radially inwardly or protrude a corresponding distance from the inner conductor track segments 35. The conductor track 17, including the positioning protrusions 18, is made of an electrically conductive and non-magnetizable material. In addition, the conductor track 17, including the positioning protrusions 18, is designed as a monolithic component. FIG. 4 shows the conductor track structure 15 in a relative position with respect to the rotor sleeve 12, also present in the injection mold.

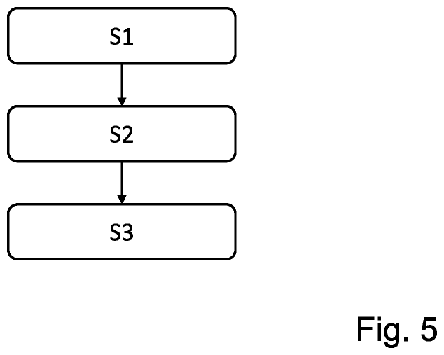

Lastly, a method for producing the rotor 11 shown in FIG. 2 is explained with reference to FIG. 5. For this purpose, in a first step S1 the conductor track structure 15 is initially positioned in an injection mold by means of the at least one positioning protrusion 18. In a further step S2 the rotor sleeve 12 is positioned in the injection mold. In a third step S3 the conductor track structure 15 is now affixed to the rotor sleeve 12 via the injection mold by means of injection molding 60.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A conductor track structure for a rotor of a rotation angle sensor, the conductor track structure comprising:
a ring-shaped conductor track with a meandering conductor track pattern; and
at least one positioning protrusion that projects inwardly in a radial direction at the conductor track for a form-fit and/or force-fit positioning of the conductor track structure in a mold.

2. The conductor track structure according to claim 1, wherein the conductor track has outer conductor track segments and inner conductor track segments, the outer conductor track segments being provided farther outwardly in a radial direction than the inner conductor track segments, and wherein a positioning protrusion projects inwardly in the radial direction is provided at at least one inner conductor track segment.

3. The conductor track structure according to claim 2, wherein in each case a positioning protrusion that projects inwardly in the radial direction is provided at multiple inner conductor track segments.

4. The conductor track structure according to claim 1, wherein multiple positioning protrusions that project inwardly in the radial direction are provided at the conductor track.

5. The conductor track structure according to claim 3, wherein the positioning protrusions project radially inwardly in a range between 0.5 mm and 2 mm.

6. The conductor track structure according to claim 1, wherein the conductor track is made of an electrically conductive and non-magnetizable material.

7. The conductor track structure according to claim 1, wherein the conductor track, including the at least one positioning protrusion, is one piece and/or is a monolithic component.

8. A rotor for a rotation angle sensor unit, the rotor comprising:
a rotor sleeve; and
a conductor track structure according to claim 1, the conductor track structure being affixed to the rotor sleeve by injection molding.

9. A rotation angle sensor unit to determine a rotational angle between the rotor according to claim 8 and a stator, comprising:
a housing that defines a housing volume;
the rotor, which is rotatably supported in the housing volume;
the stator; and
a circuit board to which the stator is affixed.

10. A method for producing a rotor according to claim 8, the method comprising:
positioning the conductor track structure in a mold via the at least one positioning protrusion;
providing the rotor sleeve in the mold; and
affixing the conductor track structure to the rotor sleeve by injection molding via the mold.
